(19) United States
(12) Patent Application Publication
(10) Pub. No.: US 2019/0014092 A1
(43) Pub. Date: Jan. 10, 2019

(54) SYSTEMS AND METHODS FOR SECURITY IN SWITCHED NETWORKS

(71) Applicants: Dan Malek, Minden, NV (US); William Rivard, Menlo Park, CA (US)

(72) Inventors: Dan Malek, Minden, NV (US); William Rivard, Menlo Park, CA (US)

(21) Appl. No.: 15/644,771

(22) Filed: Jul. 8, 2017

(51) Int. Cl. H04L 29/06; H04L 12/751; H04L 12/741; H04Q 11/00

(52) U.S. Cl. CPC H04L 63/0471; H04L 45/08; H04L 45/745; H04Q 11/0005; H04L 63/166; H04L 63/1433; H04L 63/0272; H04Q 2011/0016; H04Q 2213/13339; H04L 63/0853

(57) ABSTRACT

Security of a switched network is improved by obfuscating source and destination address information in data traffic that is vulnerable to physical attack and capture. An entry switch is configured to replace address pairs in ingress data frames with arbitrarily assigned tags. An exit switch is configured to replace the assigned tags with corresponding address pairs. Security is further enhanced by applying one or more layers of encryption to payload data while in transit within the switched network. Switch configuration is periodically refreshed to limit exposure to any successful decryption attack. By obfuscating address pair information and distributing traffic across a plurality of wavelengths in dense wavelength division multiplexing (DWDM) transmission systems, data frame affiliation is lost across wavelengths and decryption attacks on any captured data is highly confounded and limited to a small window of time between configuration refreshes.

### CROSS-REFERENCE TO RELATED APPLICATIONS

The present application claims priority to U.S. Provisional Application No. 62/359,892, entitled “SYSTEMS AND METHODS FOR SECURITY IN SWITCHED NETWORKS”, filed Jul. 8, 2016, which is hereby incorporated by references in its entirety for all purposes.

### FIELD OF THE INVENTION

The present disclosure relates generally to network security, and more particularly to systems and methods for security in switched networks.

### BACKGROUND

Switched networks typically include a collection of managed network switches configured to transmit data between endpoints. In certain implementation scenarios, the endpoints can be located in physically separate facilities, with an optical transport network providing a data transmission path between the separate facilities. In other implementation scenarios, the endpoints can be located in physically separated regions within the same machine room, with an optical transport network providing a data transmission path between the two regions. In both scenarios, the data transmission path between endpoints represents a potential security risk and overall system vulnerability. For example, data can be intercepted, captured, and recorded at one or more points along the data transmission path.

Encryption techniques have been employed to help protect the security of data transmitted between endpoints; however, certain common encryption techniques become vulnerable to attack if a sufficient record of related data can be captured. Furthermore, said encryption techniques are typically integrated into systems that can include implementation vulnerabilities that erode encryption effectiveness. Thus, there is a need for addressing this and/or other issues associated with the prior art.

### SUMMARY

A system, method, and computer readable medium are disclosed for enhancing data security in a switched network or a switched transport network. The method comprises learning, by a central authority system, endpoints within a switched network, wherein the switched network comprises at least a first entry switch and a first exit switch, and wherein the endpoints comprise network interfaces to the switched network. The method further comprises identifying, by the central authority system, end-to-end paths within the switched network, wherein the end-to-end paths traverse a first entry switch and a first exit switch, and each end-to-end path includes a first source endpoint and a first destination endpoint. The method further comprises computing, by the central authority system, a set of match-action rules for an end-to-end path, wherein the match-action rules define a first forwarding path that includes the first entry switch and the first exit switch. The method further comprises transmitting, by the central authority system, a first match-action rule from the set of match-action rules to the first entry switch and a second match-action rule from the set of match-action rules to the first exit switch. The first entry switch is configured to receive data frames from the first source endpoint and the first exit switch is configured to transmit data frames to the first destination endpoint

A non-transitory computer readable storage medium is disclosed, including programming instructions therein that, when executed by a processing unit, cause the processing unit to learn endpoints within a switched network, identify end-to-end paths within the switched network, compute a set of match-action rules for an end-to-end path, transmit a first match-action rule from the set of match-action rules to a first entry switch and a second match-action rule from the set of match-action rules to a first exit switch. The switched network comprises at least the first entry switch and the first exit switch, wherein the endpoints comprise network interfaces to the switched network. Furthermore, the end-to-end paths traverse a first entry switch and a first exit switch, and each end-to-end path includes a first source endpoint and a first destination endpoint. The match-action rules define a first forwarding path that includes the first entry switch and the first exit switch. Furthermore, the first entry switch is configured to receive data frames from the first source endpoint and the first exit switch is configured to transmit data frames to the first destination endpoint.

### BRIEF DESCRIPTION OF DRAWINGS

FIG. 1A illustrates a flowchart of a method for receiving match-action rules at an entry switch, in accordance with one embodiment.

FIG. 1B illustrates a flowchart of a method for performing match-action rules at the entry switch, in accordance with one embodiment.

FIG. 1C illustrates a first exemplary match-action rule for the entry switch, in accordance with one embodiment.

FIG. 1D illustrates a first exemplary data frame mapping based on the first exemplary match-action rule for the entry switch, in accordance with one embodiment.

FIG. 1E illustrates a second exemplary match-action rule for the entry switch, in accordance with one embodiment.

FIG. 1F illustrates a second exemplary data frame mapping based on the second exemplary match-action rule for the entry switch, in accordance with one embodiment.

FIG. 2A illustrates a flowchart of a method for receiving match-action rules at an intermediate switch, in accordance with one embodiment.

FIG. 2B illustrates a flowchart of a method for performing match-action rules at the intermediate switch, in accordance with one embodiment.

FIG. 2C illustrates a first exemplary match-action rule for the intermediate switch, in accordance with one embodiment.

FIG. 2D illustrates a first exemplary data frame mapping based on the first exemplary match-action rule for the intermediate switch, in accordance with one embodiment.

FIG. 2E illustrates a second exemplary match-action rule for the intermediate switch, in accordance with one embodiment.

FIG. 2F illustrates a second exemplary data frame mapping based on the second exemplary match-action rule for the intermediate switch, in accordance with one embodiment.

FIG. 3A illustrates a flowchart of a method for receiving match-action rules at an exit switch, in accordance with one embodiment.

FIG. 3B illustrates a flowchart of a method for performing match-action rules at the exit switch, in accordance with one embodiment.

FIG. 3C illustrates a first exemplary match-action rule for the exit switch, in accordance with one embodiment.

FIG. 3D illustrates a first exemplary data frame mapping based on the first exemplary match-action rule for the exit switch, in accordance with one embodiment.

FIG. 3E illustrates a second exemplary match-action rule for the exit switch, in accordance with one embodiment.

FIG. 3F illustrates a second exemplary data frame mapping based on the second exemplary match-action rule for the exit switch, in accordance with one embodiment.

FIG. 4 illustrates a flowchart of a method for configuring switches within a switched transport network to provide link security, in accordance with one embodiment.

FIG. 5A illustrates an exemplary switched transport network, in accordance with one embodiment.

FIG. 5B illustrates a switched transport network comprising a transport link, in accordance with one embodiment.

FIG. 5C illustrates transport systems and a dense wavelength division multiplexing transport link, in accordance with one embodiment.

FIG. 5D illustrates a conceptual forwarding subsystem, in accordance with one embodiment.

FIG. 5E illustrates a link security system, in accordance with one embodiment.

### DETAILED DESCRIPTION

Embodiments of the present disclosure provide data security protection within a switched transport network, the switched transport network configured to include an entry switch, an exit switch, and, optionally, one or more intermediate switches. Additional switches may comprise a first private network coupled to the entry switch and a second private network coupled to the exit switch. More generally, multiple private networks and/or multiple portions of a private network may be coupled to a switched transport network, which may include at least one entry switch and at least one exit switch coupled to each private network or portion of a private network. The terms entry switch and exit switch relate to data traffic flow direction and, in certain implementations, the same switch system may serve as both an entry switch and an exit switch for a given private network or portion of a private network. Similarly, a different switch system may serve as both an exit switch and an entry switch to a different private network or a different portion of a private network.

In certain embodiments, switches comprising one or more private networks can operate conventionally, while the entry switch, exit switch, and optional one or more intermediate switches operate according to techniques disclosed herein. In certain embodiments, computation server systems and/or data storage systems are coupled to one or more of the private networks, the private networks providing a plurality of network endpoints for the servers. A network endpoint (or just endpoint) is defined herein as a physical or logical data network interface coupled to a physical or logical device (e.g., server, computer, virtual machine) that is configured to communicate with other devices through the data network. The term endpoint can also refer to the physical or logical device attached to the physical or logical data network interface. A central authority system operates to configure the switches comprising at least portions of the switched transport network. The central authority system can include a computation server configured to execute a set of one or more software applications that perform relevant configuration operations of the switched transport network, including, without limitation, certain techniques disclosed herein. The central authority system can be coupled to individual control plane agents within each switch system through a control plane network. In one embodiment, the control plane network is implemented to be a physically distinct and/or logically isolated network from a data plane network comprising the switched transport network. In certain embodiments, communication between the central authority system and each control plane agent is conducted using an encrypted communication protocol, and each control message can be further encrypted separately from the encrypted communications protocol. Specific encryption implementation details may depend on various overall system implementation requirements.

Each control plane agent operates to manage an associated switch system, including at least one forwarding subsystem within the switch system. The forwarding subsystem can be implemented using a general-purpose processor coupled to network interfaces, a programmable forwarding hardware engine coupled to network interfaces, or any other technically feasible combination of circuits for receiving, processing, transmitting, and/or forwarding data frames through network interfaces.

In certain embodiments, data frames having a source address and a destination address (an address pair) are mapped to corresponding data frames having a tag that replaces the address pair. For example, forwarding a given data frame can include substituting an address pair with an appropriate tag (an entry switch operation) or substituting a tag with an appropriate address pair (an exit switch operation). In one embodiment, a given mapping between a specific address pair and a corresponding tag is kept secret, known to only the central authority system that generated the mapping, along with one or more entry switches, and/or one or more exit switches. In one embodiment, the tag occupies the same or substantially the same bit fields as the original address pair. The tag can further include other bit fields within the data frame. In one embodiment, a first switch system and a second switch system are each configured to act as both an entry switch and an exit switch. The first switch system receives data frames from a first data network (e.g., a first private network) and forwards the data frames to a first dense wavelength division multiplexing (DWDM) transport system. The first DWDM transport system transmits the data frames through a fiber optic cable to a second DWDM transport system. A given data frame is transmitted through the fiber optic cable at a specific wavelength (e.g., a DWDM ITU channel). In one embodiment, a physical port on the first DWDM transport switch is associated with a specific wavelength so that a data frame received at a given physical port is transmitted at a wavelength associated with the port. The second DWDM transport system receives data frames from the fiber optic cable and transmits the data frames to physical ports coupled to a second data network (e.g., a second private network). Similarly, the second DWDM transport system and the first DWDM transport system are able to operate to transmit data frames from the second data network to the first data network. In various embodiments, the fiber optic cable can include a single optical fiber for bidirectional communication or two optical fibers, each configured for unidirectional communication.

In one embodiment, a given data frame received by a switch system is forwarded to a specific physical port of the switch system based on a tag value for the data frame, with the physical port selection determining a wavelength for DWDM transmission of the data frame. Multiple mappings from a specific address pair to different tags can be configured at any one time, allowing data frames having a given address pair to be transmitted using different wavelengths at different times.

Furthermore, the central authority system can configure intermediate switches to re-tag data frames so that a tag within an ingress data frame is replaced with a different tag for a corresponding egress data frame. A given tag within an ingress data frame can be used by a switch system (e.g., an entry switch, an exit switch, an intermediate switch) to identify an egress port for the data frame. An association between a given tag and an egress port can be pre-assigned by the central authority system. The pre-assignment can be explicit or algorithmic (e.g., an explicit sequence or a pseudo-random sequence). Alternatively, pre-assignment information can include a flag that causes a switch system to forward an ingress data frame to an egress port selected randomly from a subset of egress ports (e.g., egress ports coupled to switches that are closer to a destination address).

In one embodiment, different data frames from one physical Ethernet port (e.g., coupled to a private network) of an entry switch are distributed over different egress ports of the entry switch that are coupled to a DWDM transport system, causing the different data frames to be transmitted at different wavelengths (corresponding to different ports). In this way, intercepting one wavelength would only yield a small fraction of data frames associated with a particular network data session, and intercepting all wavelengths would pose a computationally intractable combinatorial challenge compounding any computational challenge associated with decryption of intercepted data frames. In certain embodiments, multiple mappings are made between a given source address and destination address and different tags to create tag aliasing that further compounds the combinatorial challenge.

In certain embodiments, an intermediate switch is configured to replace a first tag associated with an ingress data frame with a second tag in a corresponding egress data frame, and an exit switch replaces the second tag with a source address and a destination address. In such embodiments, intermediate switches do not contain mapping information for associating a tag to a source address and destination address pair. Furthermore, mapping information at any one intermediate switch is insufficient to associated data frames at the intermediate switch with any specific network session, thereby eliminating potential value associated with an attack on a given intermediate switch.

While the following disclosure is described in conjunction with data frames, such as Ethernet frames, persons of ordinary skill in the art will recognize that the techniques disclosed herein are equally applicable in alternative implementations data network implementations. As such, the present disclosure may be applied to IP packets, ATM cells, and the like, without departing the scope and spirit of various embodiments.

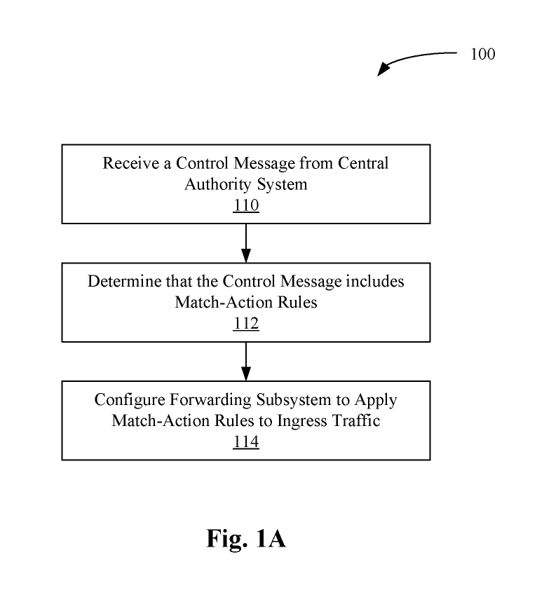

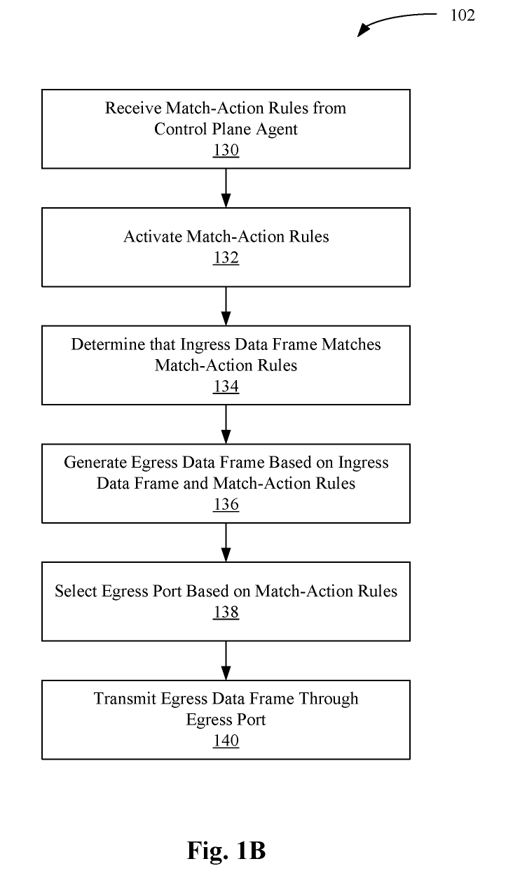

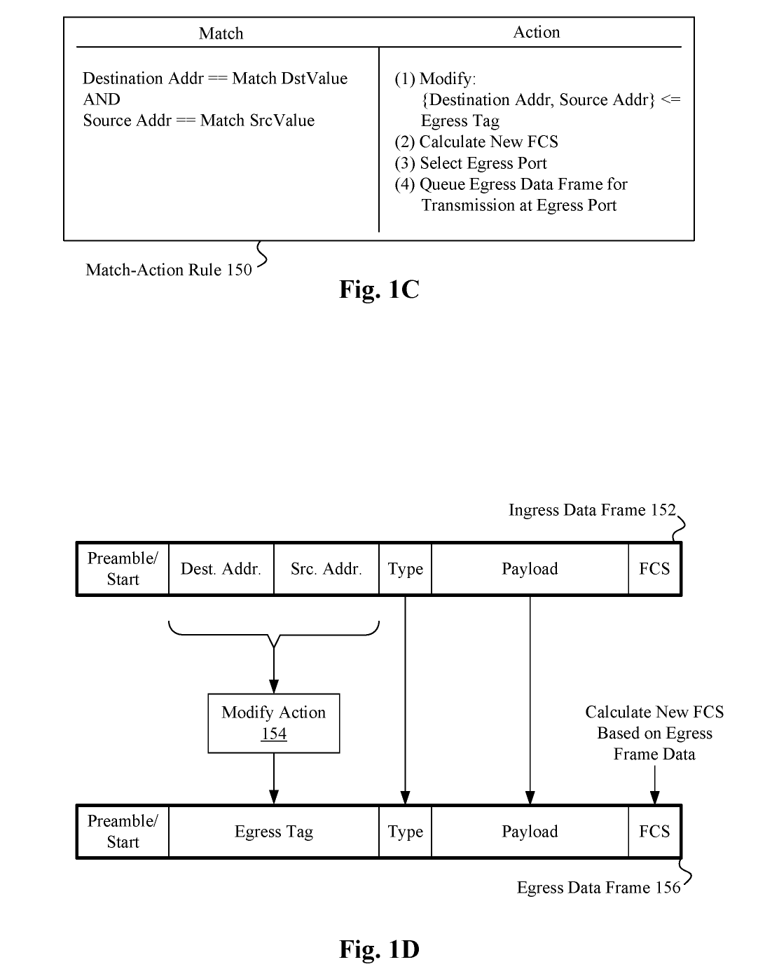

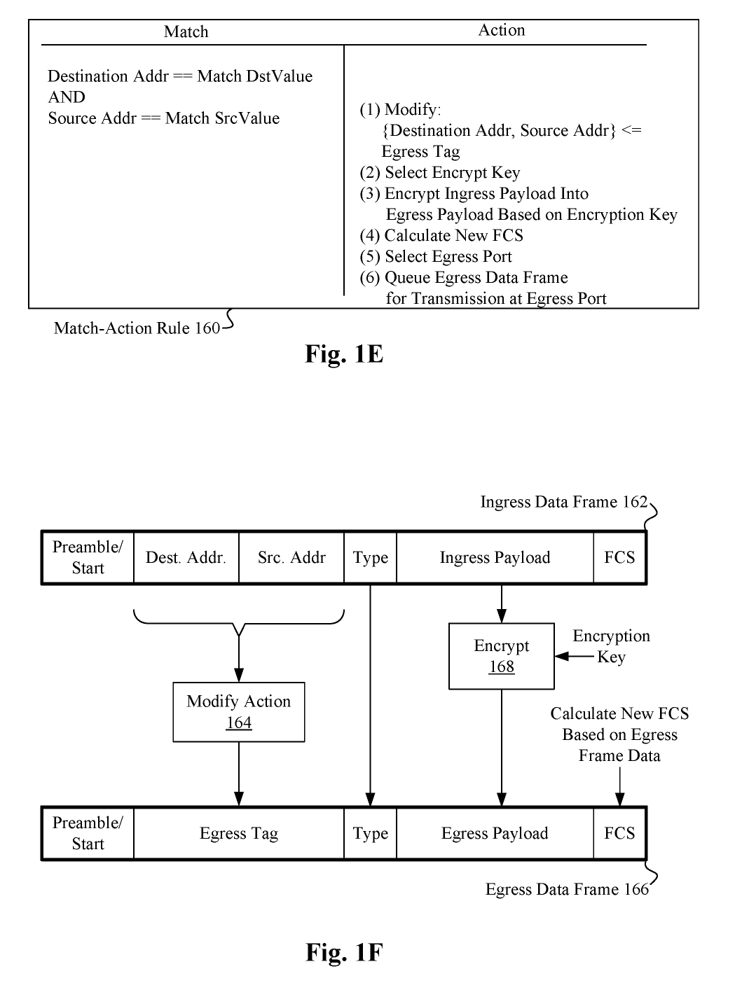

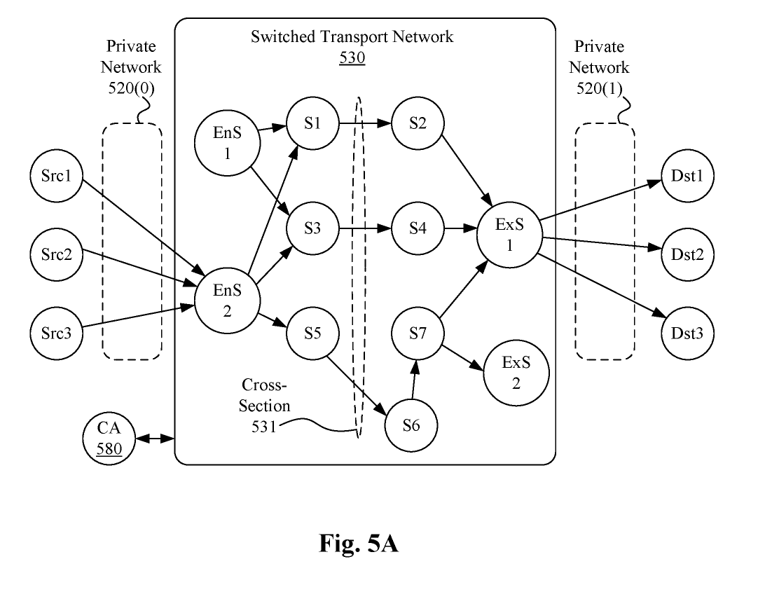

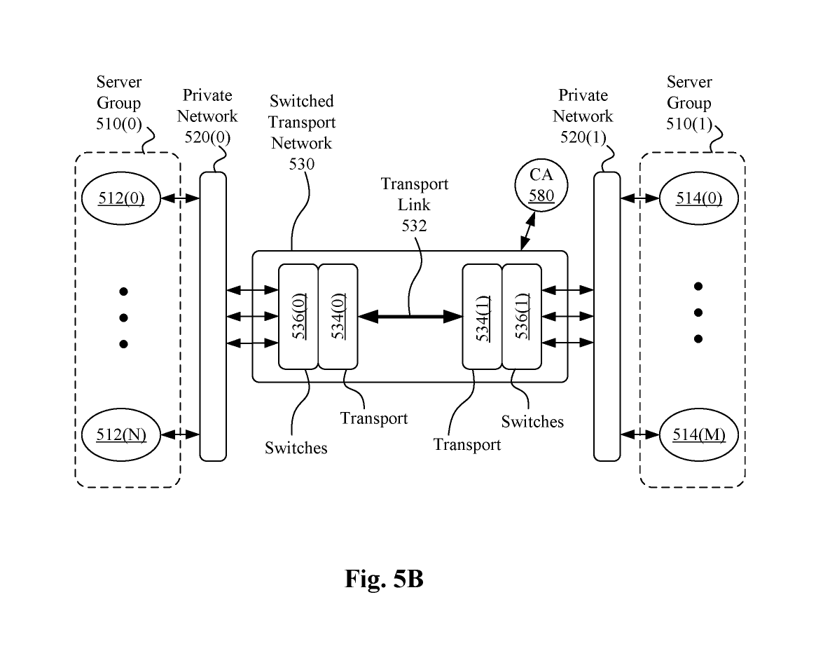

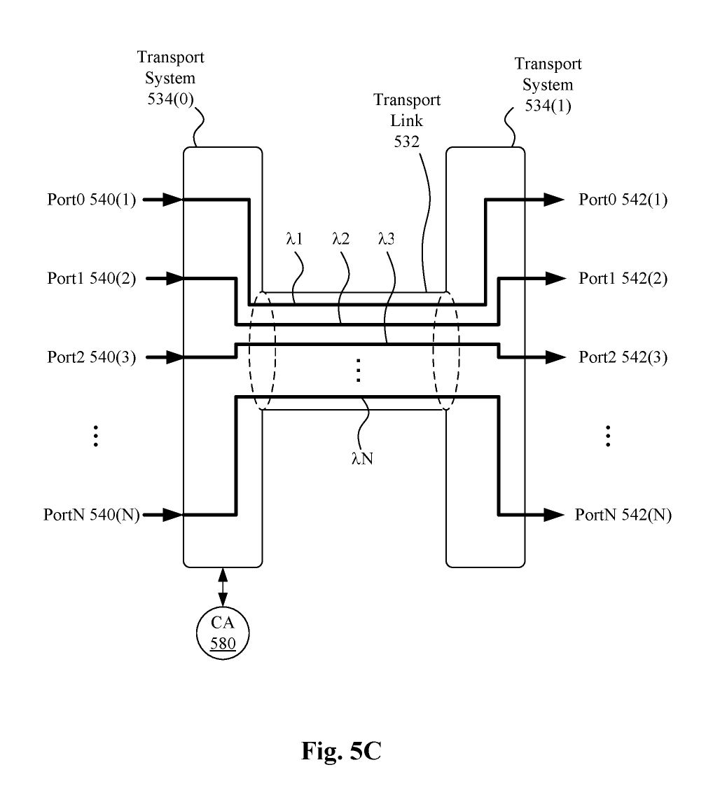

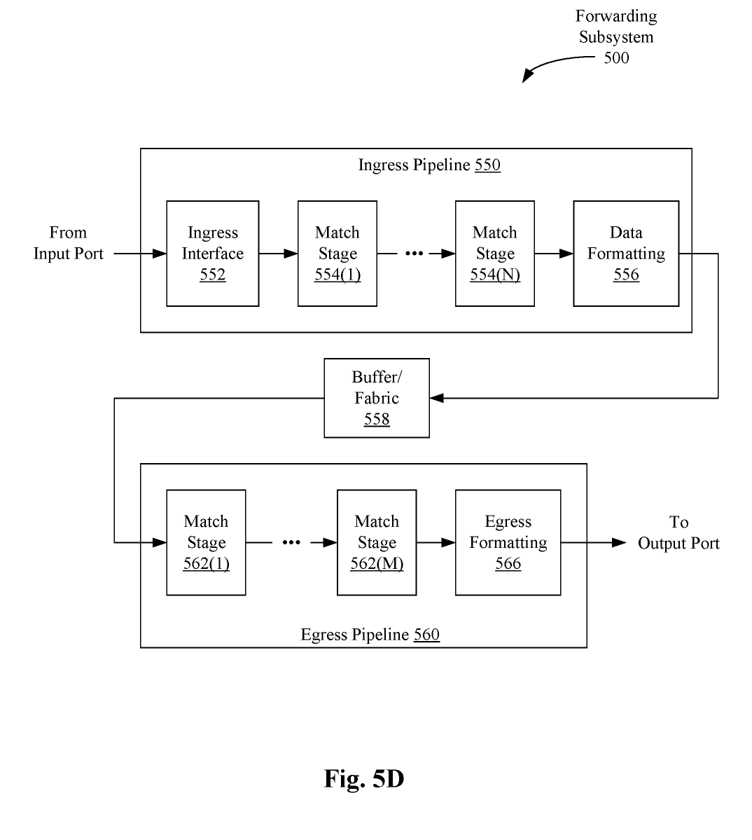

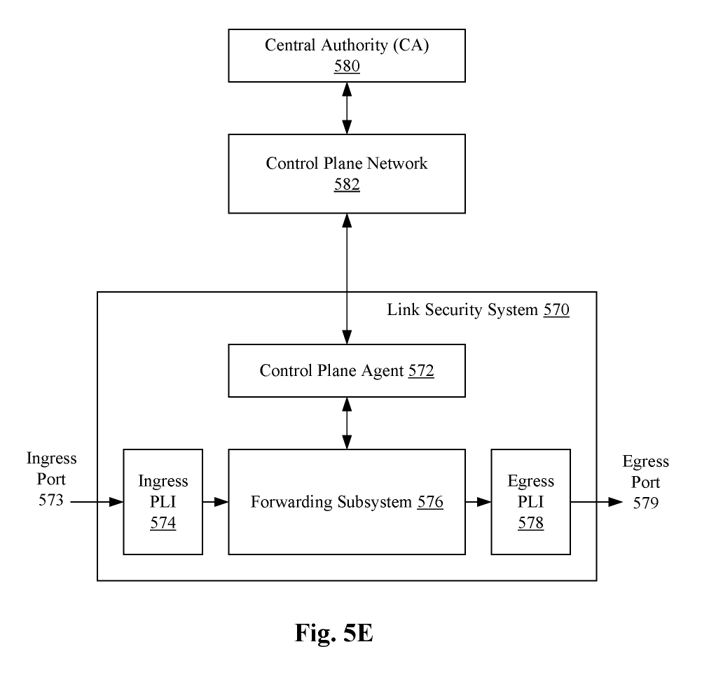

FIG. 1A illustrates a flowchart of a method 100 for receiving match-action rules at an entry switch, in accordance with one embodiment. Although method 100 is described in conjunction with the systems of FIGS. 5A-5E, persons of ordinary skill in the art will understand that any data switch system that performs method 100 is within the scope and spirit of the present disclosure. In one embodiment, a control plane agent is configured to perform method 100. The control plane agent can be implemented as a computing subsystem within the entry switch system. In one embodiment, the control plane agent is configured to receive control messages through a control plane network and configure an associated forwarding subsystem based on the control messages.

Method 100 begins at step 110, where the control plane agent receives a control message from the central authority system. In one embodiment, the control message is transmitted through the control plane network. At step 112, the control plane agent determines that the control message includes match-action rules. Exemplary match-action rules for the entry switch are illustrated in FIGS. 1C-1F. Determining that the control message includes match-action rules can include parsing the control message according to a known protocol and identifying that a specific control field or message component indicates the presence of match-action rules. The control message can comprise one or more Ethernet frames. In certain embodiments, the one or more Ethernet frames are formatted to include an internet protocol (IP) protocol packet such as a UDP or TCP/IP packet. In other embodiments, the one or more Ethernet frames are formatted to directly encode the control message within one or more corresponding payload fields. In each case, the control message can be encrypted using at least one layer of encryption. At step 114, the control plane agent configures the forwarding subsystem to apply one or more match-action rules defined in the control message to ingress traffic (e.g., ingress data frames) being processed by the forwarding subsystem. While the match-action rules are described herein as being related to ingress traffic, associated actions can be applied to egress traffic (e.g., egress data frames), and/or traffic in flight within the forwarding subsystem as well. For example, a given match may invoke an action rule that selects an egress port, egress queue, or egress queue policy.

FIG. 1B illustrates a flowchart of a method 102 for performing match-action rules at the entry switch, in accordance with one embodiment. Although method 102 is described in conjunction with the systems of FIGS. 5A-5E, persons of ordinary skill in the art will understand that any data switch system that performs method 102 is within the scope and spirit of the present disclosure. In one embodiment, method 102 is performed by a forwarding subsystem within the entry switch system.

Method 102 begins at step 130, where the forwarding subsystem receives match-action rules from the control plane agent. At step 132, the forwarding subsystem activates the received match action rules. Upon activating the received match-action rules, the forwarding subsystem is configured to perform the received match-action rules on ingress data frames. At step 134, the forwarding subsystem determines that a received ingress data frame matches a first set of match rules of the match-action rule(s). At step 136, the forwarding subsystem generates an egress data frame based on the ingress data frame and the first set of rules of the match-action rules. In one embodiment, generating the egress data frame includes applying one or more action rules corresponding to the first set of match rules. At step 138, the forwarding subsystem selects an egress port for the egress data frame based on the match-action rules. In one embodiment, the forwarding subsystem selects an egress port according to an action rule associated with the first set of match rules of the match-action rules(s). At step 140, the forwarding subsystem transmits the egress data frame through the selected egress port. In one embodiment, method 102 implements exemplary match-action rules for an entry switch, illustrated in FIGS. 1C-1F.

In one embodiment, various aspects of method 102 are implemented according to general principles taught in the fields of Software Defined Network (SDN), OpenFlow, P4, and/or related technologies. In various embodiments, other techniques beyond, or in addition to, match-action network data forwarding and/or processing can implement the principles taught herein without departing the scope of the present disclosure.

FIG. 1C illustrates a first exemplary match-action rule 150 for an entry switch, in accordance with one embodiment. When an ingress data frame satisfies match criteria for a given match-action rule, one or more specified actions are performed. The one or more actions can include mapping (copying and/or modifying) the ingress data frame into an egress data frame and selecting an egress port through which to transmit the egress data frame. A mapping process can produce an egress data frame that is different in size, structure, and content from the ingress data frame. In the context of a forwarding subsystem, match-action rules include at least one criterion that, when matched, causes the forwarding subsystem to perform one or more specified actions. The specified actions can include a null action (do nothing, discard the ingress data frame). A match rule can specify bit fields within the ingress data frame and corresponding match values for the bit fields. An action can specify partial or complete construction of an egress data frame.

As shown, a destination address (addr) and a source address (addr) are specified as exemplary match criteria for application to address fields within the header of an ingress data frame. In one embodiment, a destination address match value (DstValue) and a source address match value (SrcValue) are configured in methods 100 and 102 as part of configuring the forwarding subsystem to perform match-action rule 150. While match-action rules are illustrated in the present disclosure as comprising one or more of: a destination address, source address, and tag, a match specification can include other fields or combinations thereof. For example a match specification can include frame type and IP packet information (e.g. header fields, etc.) for frame payloads that encapsulate IP packets.

In one embodiment, if a destination address and a source address of an ingress data frame match a respective destination address match value (DstValue) and source address match value (SrcValue), then one or more associated actions specified within match-action rule 150 are performed. As shown, exemplary actions include modifying a destination address field and a source address field to be collectively equal to an egress tag. The field length for the egress tag may be different than the sum of field lengths for the destination address field and source address field. For example, the destination address and source address of an Ethernet frame are conventionally 48 bits each for a total of 96 bits. However, a corresponding tag may be only 64 bits or 32 bits. An Ethernet frame type and size field may be 16 bits in length and an IEEE 802.1Q (VLAN) tag may introduce additional multiples of 32 bits (e.g. as with stacked VLAN tags). In one embodiment, the frame type and size field are each modified to a single different tag that includes fewer total bits. More generally, a tag serves as a reference to a known (either fixed or programmatically generated) bit pattern within one or more underlying fields within a data frame. The tag needs only to include a number of bits sufficient to encode unique field values or combinations of values for the underlying fields. For example, a tag that represents a specific pairing of destination address and source address fields needs only to include a number of bits needed to uniquely encode relevant pairings within a network. For example, using a 64 bit tag to represent a 96 bit paring should be sufficient, provided an associated network includes fewer than approximately 2̂64 pairings. As discussed in greater detail herein, additional bits can be included to ensure a sufficiently sparse tag space for refreshing match-action rules during ongoing operation of the network. For example, in a network with approximately 2̂16 total pairings, a 64 bit tag may provide adequate encoding of 96 bit pairings while providing approximately 1 in 2̂48 tag code sparseness. Refreshing match-action rules is described in greater detail below. Unused tag patterns may be reused over time and may be associated with different, unrelated, match-action rules. Thus, a tag can have more bits or fewer bits than underlying data fields being represented by the tag. Furthermore, each bit pattern for each unique tag can have no correlation with bit patterns of any underlying fields. In one embodiment, the tag includes a fixed number of bits. In one embodiment, the overall frame length of an egress data frame is calculated and reflected in an applicable field. For example, a length value for an egress data frame can be calculated for the egress data frame according to length representation standards for Ethernet frames and written into an appropriate field of the egress data frame.

As shown, exemplary actions can include a modify action to map a matched address pair (e.g., destination address and source address) to a specified egress tag and writing the egress tag to an egress data frame. The egress tag can be specified as part of an action specification associated with a match-action rule specification, as disclosed in methods 100 and 102. The exemplary actions include calculating a new frame check sequence (FCS). The exemplary actions further include selecting an egress port and queuing the egress data frame for transmission through the selected egress port.

In one embodiment, the egress data frame is constructed within a working buffer, with any replicated fields from the ingress data frame copied to the working buffer. In other embodiments, the egress data frame is constructed in flight within a data processing pipeline. In still other embodiments, the egress data frame is constructed within a buffer space associated with a corresponding ingress data frame. Yet other technically feasible egress data frame construction techniques may also be implemented without departing the scope of the present disclosure.

In alternative embodiments, the tag includes a variable number of bits and implements a Huffman-style encoding of bit patterns represented in ingress data frame fields. For example, bit patterns that are measured to be more common or estimated to be more common than others can be mapped to smaller tags. In one embodiment, bit patterns (e.g., an address pair) that are estimated to be among the most common (most frequent) can be refreshed to include a smaller tag or tags relative to a previously assigned tag or tags. Any technically feasible technique can be performed to observe and/or estimate bit patter frequency. A Huffman style of coding and assigning tags may allocate a certain minimum number of bits to the tag bit field and expand the number of bits in specified quanta. For example, the tag may include a minimum of 16 bits and expand in increments of 8 bits. In one embodiment, code sparseness is preserved by allocating only a fraction of possible codes for each quantized tag length.

In certain embodiments, multiple tags encode corresponding data frame fields or sets of data frame fields. For example, an Ethernet frame type can be encoded separately from address pairs. Furthermore, multiple tags can be assigned to the same bit patterns within the frame fields. For example, a given address pair can represented by multiple different tags that are all mapped to the same address pair.

In certain embodiments, common frame constructions, such as acknowledge frames, can be represented entirely by one or more tags, with only varying data (e.g., sequence number fields) preserved in an egress data frame.

FIG. 1D illustrates a first exemplary data frame mapping based on match-action rule 150 for the entry switch, in accordance with one embodiment. As shown, destination address and source address fields from an ingress data frame 152 are mapped to an egress tag within an egress data frame 156 through a modify action 154. The modify action 154 is specified in associated match-action rules that match the destination address and source address fields. As discussed previously, a resulting egress tag may include more bits or fewer bits than the combined number of bits within the destination address and source address fields. In this exemplary first data frame mapping, a frame type field and a payload field are both preserved. In this exemplary mapping, a new FCS is computed in accordance with modified, generated, or otherwise mapped fields.

FIG. 1E illustrates a second exemplary match-action rule 160 for an entry switch, in accordance with one embodiment. Match-action rule 160 adds payload encryption to the match-action rule 150 described in FIGS. 1C-1D, so that an ingress payload within an ingress data frame (e.g., ingress data frame 162 of FIG. 1F) is encrypted to generate an egress payload within a corresponding an egress data frame (e.g. egress data frame 166), based on an encryption key. In one embodiment, the encryption key is specified as part of match-action rule 160. In certain embodiments, the type field and/or other fields can also be encrypted.

As shown, exemplary actions can include a modify action (e.g., modify action 164) to map a matched destination address and source address pair to a specified egress tag. This action can include writing the egress tag to the egress data frame. The egress tag (e.g., a specific bit pattern or value for the tag) can be specified (e.g., according to methods 100 and 102) as part of an action specification associated with match-action rule 160. The exemplary actions further include an encryption operation (e.g., encryption operation 168) applied to an ingress payload to generate a corresponding egress payload based on the ingress payload and an encryption key. The encryption key can be specified as part of the exemplary actions. Other fields (e.g., type field) may also be similarly encrypted. The exemplary actions can include calculating a new frame check sequence (FCS). The exemplary actions can further include selecting an egress port, and queuing the egress data frame for transmission through the selected egress port.

FIG. 1F illustrates a second exemplary data frame mapping based on match-action rule 160 for the entry switch, in accordance with one embodiment.

As shown, an address pair comprising a destination address field (Dest. Addr.) and a source address field (Src. Addr.) is mapped to an egress tag through a modification action 164 specified in match-action rule 160. As discussed previously, a resulting egress tag can include more bits or fewer bits than the combined number of bits within the destination address and source address fields. In this second exemplary data frame mapping, at least an ingress payload field of ingress data frame 162 is encrypted for transmission in egress data frame 166. As shown, encryption operation 168 encrypts the payload field. Other fields may also be similarly encrypted. A new FCS can be computed in accordance with other modified/mapped fields included within egress data frame 166.

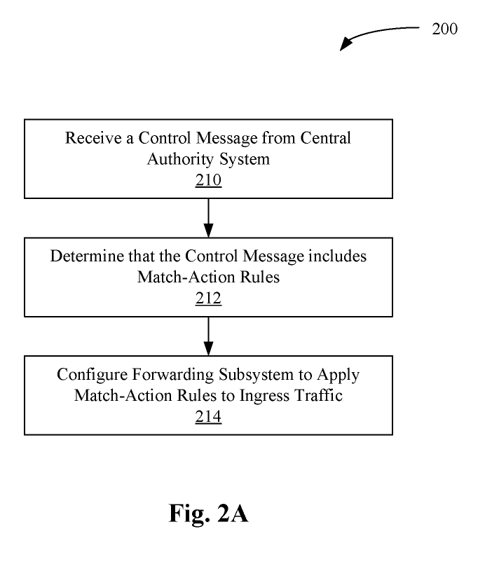

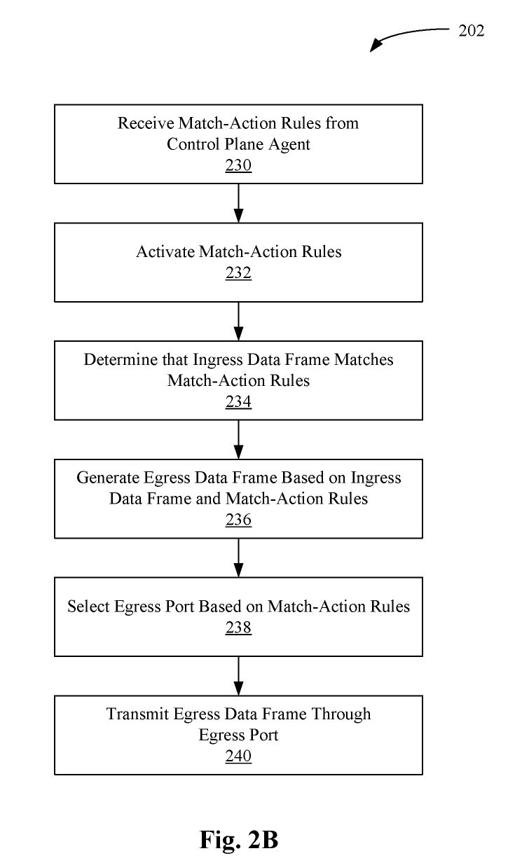

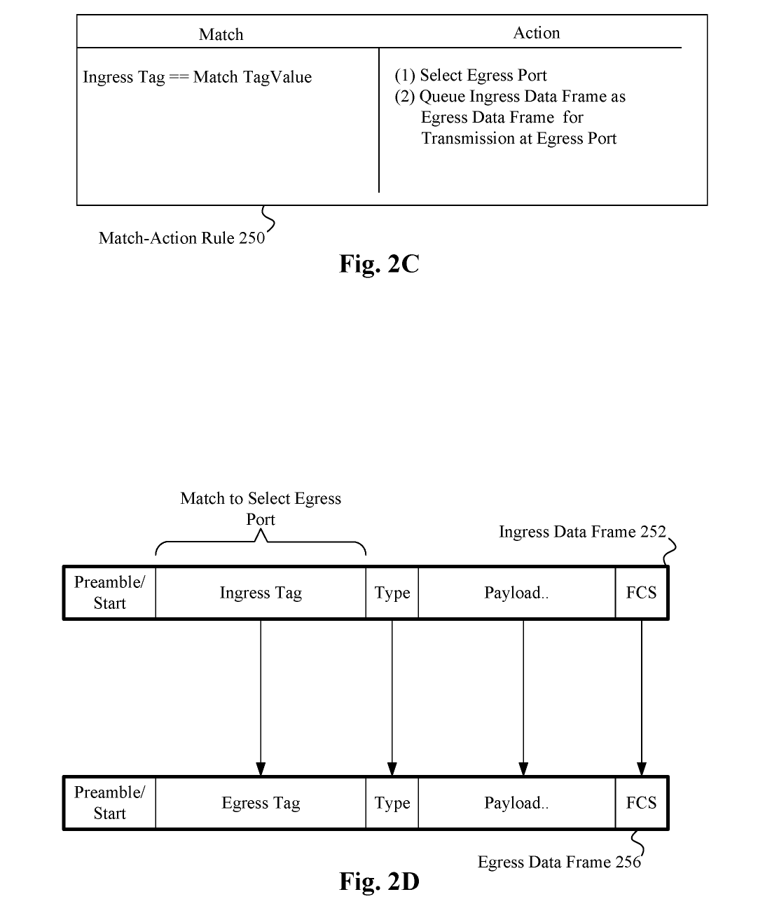

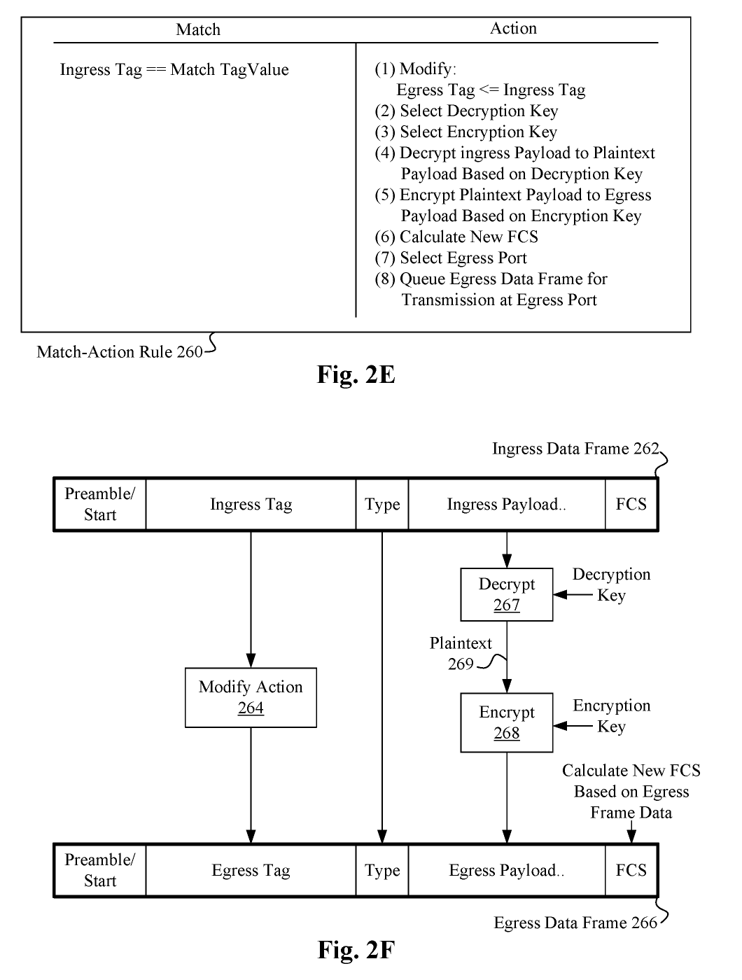

FIG. 2A illustrates a flowchart of a method 200 for receiving match-action rules at an intermediate switch, in accordance with one embodiment. Although method 200 is described in conjunction with the systems of FIGS. 5A-5E, persons of ordinary skill in the art will understand that any data switch system that performs method 200 is within the scope and spirit of the present disclosure. In one embodiment, a control plane agent is configured to perform method 200. The control plane agent can be implemented as a computing subsystem within the intermediate switch system. In one embodiment, the control plane agent is configured to receive control messages through a control plane network and configure an associated forwarding subsystem based on the control messages.

Method 200 begins at step 210, where the control plane agent receives a control message from the central authority system. In one embodiment, the control message is transmitted through the control plane network. At step 212, the control plane agent determines that the control message includes match-action rules. Determining that the control message includes match-actions rules can be performed according to the discussion of method 100. Exemplary match-action rules for the intermediate switch are illustrated in FIGS. 2C-2F. At step 214, the control plane agent configures the forwarding subsystem to apply one or more match-action rules defined in the control message to ingress traffic being processed by the forwarding subsystem.

In general, method 200 substantially follows the overall method steps of method 100, with the goal of method 200 being the configuration of an intermediate switch rather than an entry switch.

FIG. 2B illustrates a flowchart of a method 202 for performing match-action rules at the intermediate switch, in accordance with one embodiment. Although method 202 is described in conjunction with the systems of FIGS. 5A-5E, persons of ordinary skill in the art will understand that any data switch system that performs method 202 is within the scope and spirit of the present disclosure. In one embodiment, method 202 is performed by a forwarding subsystem within the intermediate switch system.

Method 202 begins at step 230, where the forwarding subsystem receives match-action rules from the control plane agent. At step 232, the forwarding subsystem activates the received match action rules. Upon activating the received match-action rules, the forwarding subsystem is configured to perform the received match-action rules on ingress data frames. At step 234, the forwarding subsystem determines that an ingress data frame matches a first set of match rules of the match-action rule(s). At step 236, the forwarding subsystem generates an egress data frame based on the ingress data frame and the first set of rules of the match-action rule(s). In one embodiment, generating the egress data frame includes applying one or more action rules corresponding to the first set of match rules. At step 238, the forwarding subsystem selects an egress port for the egress data frame based on the match-action rules. In one embodiment, the forwarding subsystem selects an egress port according to an action rule associated with the first set of match rules of the match-action rule(s). At step 240, the forwarding subsystem transmits the egress data frame through the selected egress port. In one embodiment, method 202 implements exemplary match-action rules for an intermediate switch illustrated in FIGS. 2C-2F.

In general, method 202 substantially follows the overall method steps and principles of method 102, with method 202 directed to processing within an intermediate switch rather than an entry switch.

FIG. 2C illustrates a first exemplary match-action rule 250 for an intermediate switch, in accordance with one embodiment. Match-action rule 250 matches fields within an ingress data frame (e.g., ingress data frame 252 of FIG. 2D) to select an egress port, which can be specified as an action rule for match-action rule 250. The ingress data frame is then queued for transmission as an egress data frame. In one embodiment, the ingress data frame is copied from an ingress buffer to an egress buffer for transmission. As shown, an ingress tag may comprise a match field for associated match-action rules. In certain embodiments, the payload field is decrypted for the purpose of matching additional fields, such as fields associated with an IP packet that is encapsulated within the payload field. In such embodiments, the ingress payload can still be copied to an egress data frame payload unmodified, but certain fields can provide additional fields for additional match rules (not shown).

FIG. 2D illustrates a first exemplary data frame mapping based on match-action rule 250 for the intermediate switch, in accordance with one embodiment. As shown, at least an ingress tag within an ingress data frame is tested in a match-action rule to select an egress port. In general, an ingress data frame 252 is received and forwarded (e.g., transmitted unmodified) as an egress data frame 256 to the selected egress port.

FIG. 2E illustrates a second exemplary match-action rule 260 for an intermediate switch, in accordance with one embodiment. As shown, a match rule of the match-action rule 260 comprising matching an ingress tag to a match tag value (TagValue). In certain embodiments, additional match criteria can also be included. Furthermore, the exemplary actions can optionally include a modify action (e.g., modify action 264 of FIG. 2F) to map a matched ingress tag within an ingress data frame (e.g., ingress data frame 262) to a specified different egress tag, and/or writing the egress tag to an egress data frame (e.g., egress data frame 266). The egress tag can be specified (e.g., as disclosed in methods 200 and 202) as part of an action specification associated with a match-action rule specification. The exemplary actions can further include selecting a decryption key, selecting an encryption key, decrypting an ingress payload to generate a plaintext payload based on the selected decryption key and the ingress payload, encrypting the plaintext payload to generate an egress payload based on the plaintext payload and the encryption key, and calculating a new FCS. Alternatively, the exemplary actions can further include selecting an encryption key based on an action associated with the ingress tag and applying an additional layer of encryption to the payload. The exemplary actions further include selecting an egress port for the egress data frame, and queuing the egress data frame for transmission through the selected egress port. While only the ingress payload is shown being encrypted other data fields (e.g. type field) within the ingress data frame may also be similarly encrypted.

The disclosed technique is independent of and orthogonal to any inherent structure of plaintext payload data, which itself may comprise encrypted data, such as encrypted data from a secure socket layer (SSL) or virtual private network (VPN) session.

In one embodiment, the ingress payload comprises an IP packet that is encrypted in its entirety, including headers and other related fields. In certain embodiments, a decrypted ingress payload provides IP header fields that may themselves be included in matching rules. In such embodiments, the match-action rules may be nested to include a decryption action followed by a matching function.

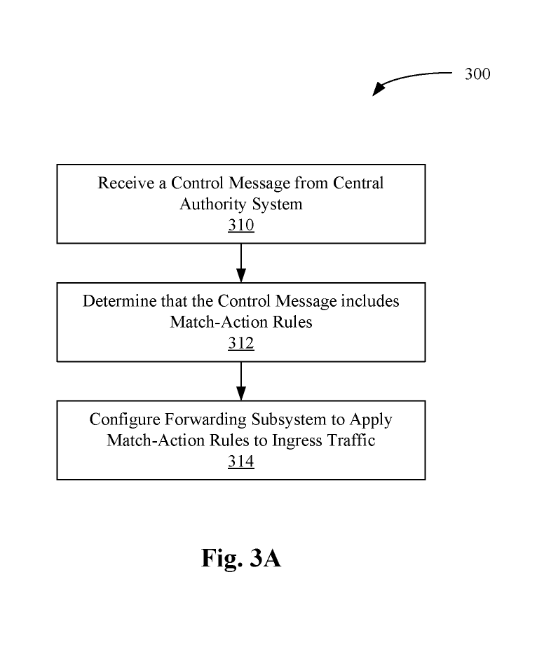

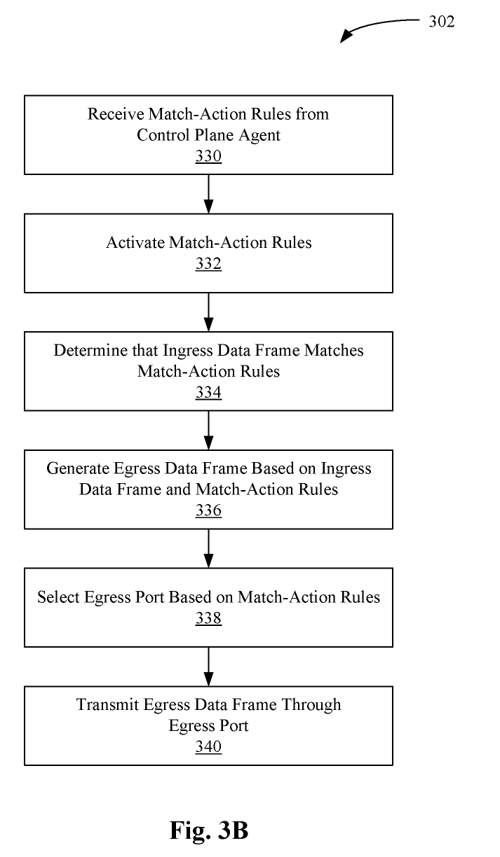

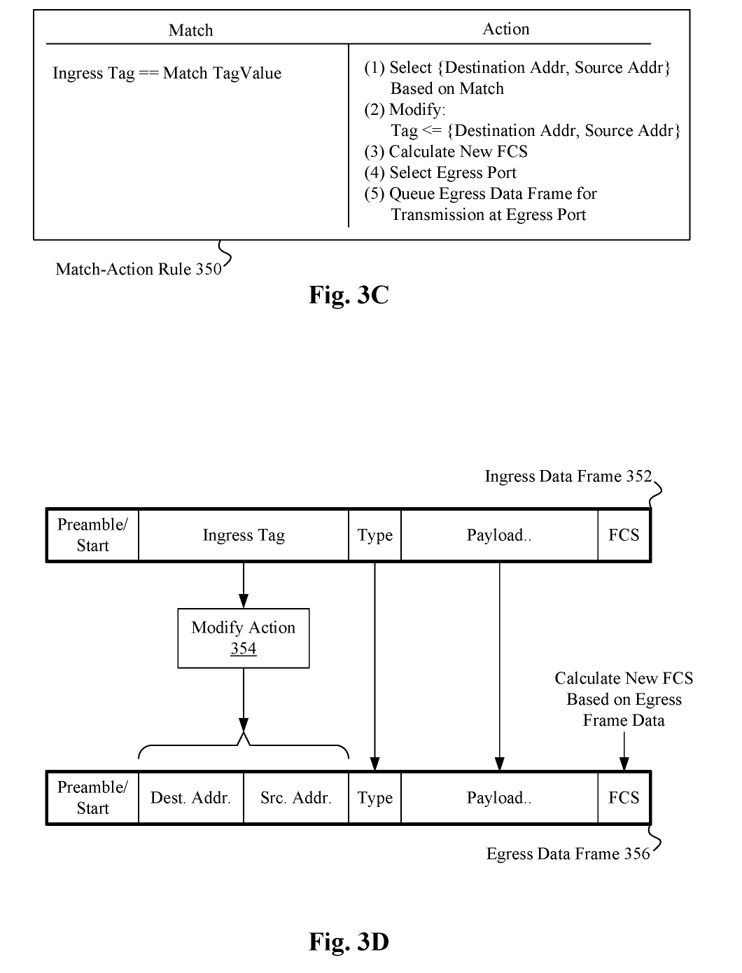

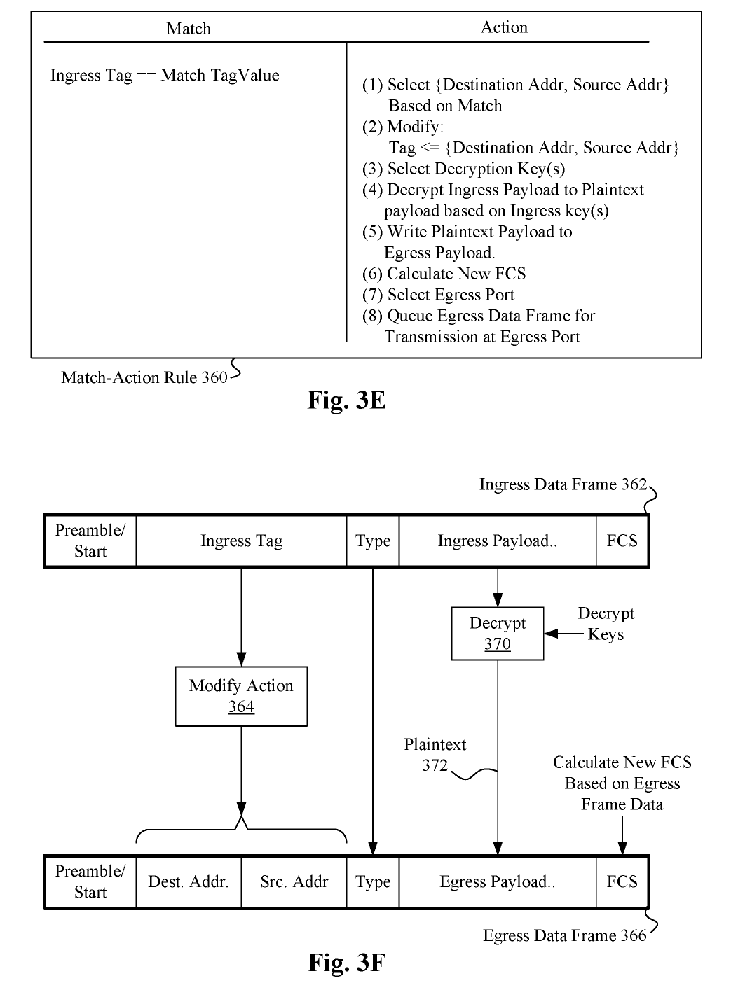

In certain embodiments, the decryption action is not performed, and instead the ingress payload is encrypted directly within an addition layer of an encryption stack, and decryption of data frame payloads is performed as a de-stacking operation described below in FIGS. 3A-3F in conjunction with the operation of an exit switch.

Whether each ingress payload is first decrypted into a plaintext payload, which is then encrypted to generate the egress payload, or the ingress payload is directly encrypted to generate the egress payload, an egress data frame is advantageously uncorrelated in data content with an ingress data frame. Consequently, capturing a complete data stream of egress data frames presents a combinatorial explosion for decryption attacks because any two different frames may be related or unrelated and an attacker has no way of discerning affiliation between different data frames. Not knowing which frames are related to each other creates a combinatorial explosion that compounds the inherent computational challenge of a direct cryptographic attack.

FIG. 2F illustrates a second exemplary data frame mapping based on match-action rule 260 for an intermediate switch, in accordance with one embodiment. As shown, an ingress tag within an ingress data frame 262 is mapped to an egress tag within an egress data frame 266 through a modify action 264 specified in an associated match-action rule that matches the ingress tag (e.g., a matching instance of match-action rule 260). A resulting egress tag can include more bits or fewer bits than the ingress tag. In this second exemplary data frame mapping, at least an ingress payload field is encrypted. Other fields may also be encrypted. A new FCS is computed in accordance with modified, generated, or otherwise mapped fields. As shown, a decrypt operation 267 decrypts the ingress payload to generate a plaintext payload 269 representation of the ingress payload. The plaintext payload 269 is then encrypted using encrypt operation 268 to generate the egress payload. In one embodiment, decrypt operation 267 uses a decryption key selected as an action rule matched by the ingress tag and the encryption operation 268 uses an encryption key selected as an action rule matched by the ingress tag. Encryption operation 268 and decryption operation 267 are both optional operations at any given intermediate switch. For example, a series of N (N>0) intermediate switches can be configured to apply different encryption operations 268 to ingress payloads, whereby applying N layers of encryption, while a subsequent series of N intermediate switches can be configured to apply corresponding decryption operations 267 to sequentially remove the layers of encryption to produce an original payload prior to encryption by an intermediate switch. Encryption operations can similarly be applied at an entry switch and decryption operations can similarly be applied at an exit switch.

FIG. 3A illustrates a flowchart of a method 300 for receiving match-action rules at an exit switch, in accordance with one embodiment. Although method 300 is described in conjunction with the systems of FIGS. 5A-5E, persons of ordinary skill in the art will understand that any data switch system that performs method 300 is within the scope and spirit of the present disclosure. In one embodiment, a control plane agent is configured to perform method 300. The control plane agent can be implemented as a computing subsystem within the exit switch system. In one embodiment, the control plane agent is configured to receive control messages through a control plane network and configure an associated forwarding subsystem based on the control messages.

Method 300 begins at step 310, where the control plane agent receives a control message from the central authority system. In one embodiment, the control message is transmitted through the control plane network. At step 312, the control plane agent determines that the control message includes match-action rules. Determining that the control message includes match-actions rules can be performed according to the discussion of method 100. Exemplary match-action rules for the exit switch are illustrated in FIGS. 3C-3F. At step 314, the control plane agent configures the forwarding subsystem to apply one or more match-action rules defined in the control message to ingress traffic being processed by the forwarding subsystem.

In general, method 300 substantially follows the overall method steps of method 100, with the goal of method 300 being the configuration of an exit switch rather than an entry switch.

FIG. 3B illustrates a flowchart of a method 302 for performing match-action rules at the exit switch, in accordance with one embodiment. Although method 202 is described in conjunction with the systems of FIGS. 5A-5E, persons of ordinary skill in the art will understand that any data switch system that performs method 302 is within the scope and spirit of the present disclosure. In one embodiment, method 302 is performed by a forwarding subsystem within the exit switch system.

Method 302 begins at step 330, where the forwarding subsystem receives match-action rules from the control plane agent. At step 332 the forwarding subsystem activates the received match action rules. Upon activating the received match-action rules, the forwarding subsystem is configured to perform the received match-action rules on ingress data frames. At step 334 the forwarding subsystem determines that an ingress data frame matches a first set of match rules of the match-action rule(s). At step 336, the forwarding subsystem generates an egress data frame based on the ingress data frame and the first set of rules of the matched match-action rule(s). In one embodiment, generating the egress data frame includes applying one or more action rules corresponding to the first set of match rules. At step 338, the forwarding subsystem selects an egress port for the egress data frame based on the matched match-action rule(s). In one embodiment, the forwarding subsystem selects an egress port according to an action rule associated with the first set of match rules of the match-action rule(s). At step 340, the forwarding subsystem transmits the egress data frame through the selected egress port. In one embodiment, method 302 implements exemplary match-action rules for an exit switch illustrated in FIGS. 3C-3F.

In general, method 302 substantially follows the overall method steps and principles of method 102, with method 302 directed to processing within an exit switch rather than an entry switch.

FIG. 3C illustrates a first exemplary match-action rule 350 for an exit switch, in accordance with one embodiment. As shown, the first exemplary match rule of match-action rule 350 comprises matching an ingress tag from an ingress data frame (e.g., ingress data frame 352 of FIG. 3D). Exemplary actions to be performed in response to matching the ingress tag can include selecting a destination address and source address pair, and a modify action to map the destination address and source address pair into an egress data frame (e.g. egress data frame 356). Additional actions may include calculating a new FCS for the egress data frame, selecting an egress port, and queuing the egress data frame for transmission through the selected egress port.

FIG. 3D illustrates a first exemplary data frame mapping based on match-action rule 350 for the exit switch, in accordance with one embodiment. As shown, an ingress tag within ingress data frame 352 is mapped to an address pair comprising a destination address (Dest. Addr.) and source address (Src. Addr.) within egress data frame 356 through a modify action 354. In one embodiment, the modify action 354 is specified in associated match-action rules that match the ingress tag field, such as match-action rule 350. In this exemplary mapping, a new FCS may be computed in accordance with modified, generated, or otherwise mapped fields within the egress data frame.

FIG. 3E illustrates a second exemplary match-action rule 360 for an exit switch, in accordance with one embodiment. As shown, a match rule of the match-action rule 360 comprises matching an ingress tag to a match tag value (TagValue) from an ingress data frame (e.g., ingress data frame 362 of FIG. 3F). Exemplary actions can include an action to select an address pair comprising a destination address and a source address, and a modify action to map (e.g., write) the address pair into an egress data frame (e.g., egress data frame 366). Further actions can include selecting one or more decryption keys, decrypting the ingress payload into a plaintext payload based on the selected one or more decryption keys, and writing the plaintext payload to the egress payload field of the egress data frame. Additional actions can include calculating a new FCS for the egress data frame, selecting an egress port, and queuing the egress data frame for transmission through the selected egress port.

FIG. 3F illustrates a second exemplary data frame mapping based on match-action rule 360 for an exit switch, in accordance with one embodiment. As shown, an ingress tag within ingress data frame 362 is mapped to an address pair comprising a destination address and a source address through a modification action 364. In one embodiment, the modification action 364 is specified in an associated match-action rule that matches the ingress tag field (e.g., a matching instance of match-action rule 360). In one embodiment, an ingress payload is decrypted by a decrypt operation 370 into a plaintext payload 372 that is written to an egress payload field of an egress data frame 366. In one embodiment, the decrypt operation 370 uses one or more decrypt keys (a key set) to decrypt one or more corresponding layers of encryption protecting a plaintext version of ingress payload. In one embodiment, the ingress payload is encrypted according to stacked encryption layers, and the decrypt operation 370 is implemented according to an inverse stacked decryption process of sequential decryption operations. Each encryption layer can have a different encryption key and each stack of encryption layers can have a key set with different keys per layer. Similarly, each decryption layer can have a different decryption key from a decryption key set. In one embodiment, the decryption key set is specified as part of an action comprising a match-action rule associated with a matching ingress tag. In general, decryption keys within a given decryption key set can be specified in the match-action rules associated with the ingress tag. The plaintext payload 372 can itself comprise encrypted data, such as data from an SSL session or VPN session. A new FCS can be computed in accordance with modified, generated, or otherwise mapped fields within the egress data frame.

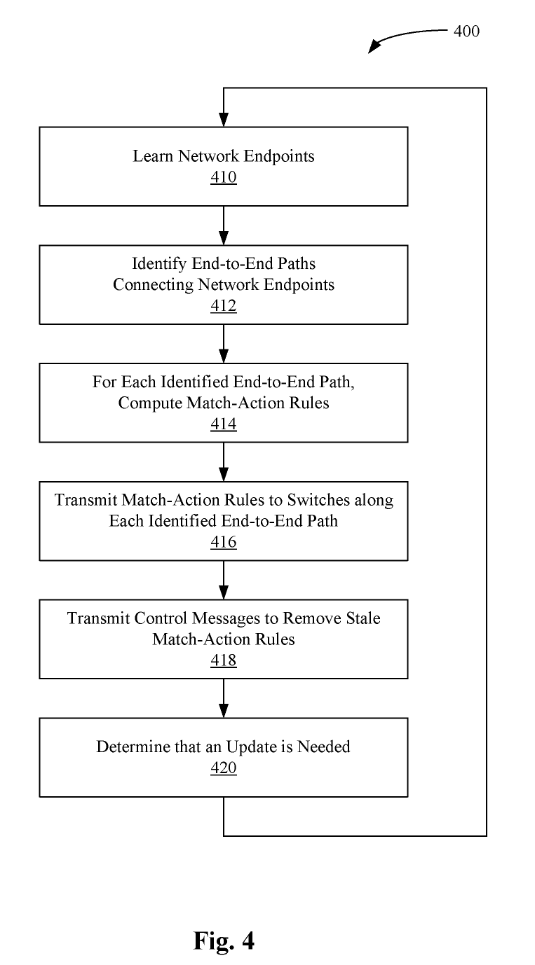

FIG. 4 illustrates a flowchart of a method 400 for configuring switches within a switched transport network to provide link security, in accordance with one embodiment. Method 400 is performed by a central authority, which can be implemented as a computer server system configured to execute one or more software applications that implement at least method 400. The computer server system comprises network interface circuitry for communicating with control plane agents. In one embodiment, each control plane agent is configured to manage and control one or more switch system within the switched transport network. In one embodiment, communication between the central authority and control plane agents is conducted through a control plane network, which can be encrypted and physically and/or logically isolated from other traffic (e.g. primary traffic) within the switched transport network. In one embodiment primary traffic is transmitted through a DWDM transmission system and the control plane network traffic is not transmitted through the DWDM transmission system. In light of the teaching provided herein, persons of ordinary skill in the art will understand that any computation system that performs method 400 is within the scope and spirit of the present disclosure. Furthermore, the control plane network can implement any technically feasible network architecture.

Method 400 begins at step 410, where the central authority learns network endpoints. In one embodiment, the central authority learns the network endpoints by being told, such as through an explicit configuration process. For example, a system-wide inventory may provide all endpoints along with applicable network operations policy for connecting different endpoints together. In another embodiment, the central authority learns the network endpoints by discovery. The central authority can implement any technically feasible endpoint discovery protocol and procedure. In certain embodiments, the central authority is configured to learn the network endpoints dynamically (incrementally) and track changes in the switched transport network. Incremental changes can be learned by the central authority through explicit configuration information, discovered through an ongoing endpoint discovery process, or a combination thereof. Incremental changes can include, without limitation, link status (link up, link down), switch status (system up, system down, system failing), any system reboots, new systems brought on line within the network, decommissioned systems dropped from the network, and the like.

At step 412, the central authority identifies end-to-end paths connecting the learned network endpoints. In one embodiment, only certain end-to-end paths are identified between endpoints that are specified to be connected. The end-to-end paths can be identified based on any technically feasible algorithm, including any cost function optimization algorithm. Exemplary cost functions include, without limitation, path length, path latency, link utilization, intermediate switch load, or various combinations thereof. Furthermore, the end-to-end paths can be stated explicitly and identifying the end-to-end paths can comprise selecting among predetermined paths. In certain embodiments, an end-to-end path can include a selection of different paths through the switched transport network, so that traffic between two endpoints is diffused over multiple different paths. In the context of the present disclosure, the end-to-end paths traverse at least one entry switch and at least one exit switch.

At step 414, the central authority computes match-action rules for each end-to-end path. The match-action rules for each end-to-end path are computed to define a unidirectional forwarding path for data frames from a source system at an endpoint to a destination system at another endpoint. In the context of an address pair, a source endpoint corresponds to a source address within a data frame and a destination address within a data frame corresponds to a destination endpoint. That is, a source endpoint transmits a data frame having a source address for the source endpoint, and the data frame has a destination address for the destination endpoint. In one embodiment, the forwarding path includes an entry switch configured to forward data frames having a source address for the source endpoint and an exit switch configured to forward data frames having a destination address for the destination endpoint. The forwarding path can further include one or more intermediate switches. A different set of match-action rules for each switch (e.g., the entry switch, the exit switch, the one or more intermediate switches) are configured along a given forwarding path to forward data frames from the source endpoint to the destination endpoint. Bidirectional communication between two different systems includes at least two unidirectional paths, comprising a first unidirectional path from a first of the two systems to a second of the two systems, and a second unidirectional path from the second system to the first system. In certain cases, both unidirectional paths can be threaded through the same switch systems. In other cases, each unidirectional path is threaded through at least one different switch system. In yet other cases, the unidirectional paths may share certain switch systems, but diverge at other switch systems. Each unidirectional path is threaded through an entry switch and an exit switch.

In one embodiment, threading a unidirectional end-to-end path through a switched transport network to perform unidirectional forwarding along the end-to-end path includes configuring an entry switch to perform a mapping from an address pair and a tag. Furthermore, an exit switch is configured to map the tag to the address pair. These two mapping operations provide for conventionally-constructed data frames entering and exiting the switched transport network, while providing tag-based forwarding along links within the switched transport network. Intermediate switches are configured by the central authority to forward data frames along identified end-to-end paths according to tag values. The tag values only convey forwarding information at a given intermediate switch but otherwise provide no endpoint information or affiliation to other data frames. In one embodiment, threading the end-to-end path includes determining a set of tag-to-egress port match-action rules for switches within the switched transport network, such that the set of egress ports establish the end-to-end path along existing links between the switches. Any technically feasible techniques may be used to implement the threading along end-to-end paths so that entry switches, intermediate siwtches, and exit switches perform intended forwarding operations.

In certain embodiments, the match-action rules include specifying encryption keys for encrypting data frame fields (e.g., payload fields). For such embodiments, decryption keys are provided by the central authority to appropriate switch systems to decrypt encrypted data. The decryption keys can be configured within match-action rules for switches along an end-to-end path (e.g., each switch performs decryption using one key and re-encryption using a different key) or configured in match-action rules specifying decryption de-stacking within just and exit switch (decryption of each encryption layer until fully decrypted).

At step 416, the central authority transmits the computed match-action rules to switches along each identified end-to-end path. The match-action rules can be transmitted as control messages to control plane agents configured to manage corresponding switches. In one embodiment, the control messages are transmitted through a physically and/or logically isolated control plane network. In certain embodiments the control messages are encrypted and/or transmitted through the control plane network. In certain embodiments, the control messages are delivered to switches within the switched transport network using non-networked physical media. In one embodiment, the match-action rules are organized according to different switch systems, so that match-action rules for a given switch system are organized into a set of match-action rules for the switch system.

At step 418, the central authority transmits one or more messages, such as control messages, to remove stale match-action rules. During normal operation, the central authority may thread end-to-end paths using different match-action rules that specify different tags and/or encryption/decryption keys. Once a new end-to-end path is threaded for two given endpoints, match-action rules associated with a previous end-to-end path between the two endpoints can be designated to be stale and subsequently removed to make space for new match-action rules within one or more associated forwarding subsystems. In certain embodiments, portions of an end-to-end path may be re-threaded in this way rather than an entire end-to-end path. By changing tags and encryption keys periodically, complexity associated with any decryption attack is compounded by ever-changing keys, and any potentially compromised data is limited in size. Furthermore, any association of a tags and data frame steams become invalid as tags are changed. In certain embodiments, multiple end-to-end paths are threaded between two identical endpoints for simultaneous operation.

At initialization for any given switch within the switched transport network, there may or may not be pre-existing stale match-action rules. Similarly, at a system-wide initialization there may or may not be pre-existing stale match-action rules within constituent switches. In ongoing operation, the central authority replaces stale rules with new/current rules. In one embodiment, the central authority continuously refreshes end-to-end paths between endpoints, replacing end-to-end paths with new tags. The central authority can also replace a given threading (path from switch system to switch system) between two endpoints with a different threading. Tag values are arbitrary and may be random. However, tag values configured for operation in match-action rules at a given switch system are generally unique at ingress and/or egress at the switch system. In certain configurations, a given tag value within an ingress data frame can have a specific match within the match-action rules, but the same tag value can be assigned for mapping in a different action in a different match-action rule to generate an egress data frame.

At step 420, the central authority determines that an update is needed. Determining that an update is needed may be in response to a change in status of a network system (e.g., a switch system), a network link, or presentation of a newly added network system, network link, endpoint, or other resource. More generally, any change in network topology or operation may cause a determination that an update is needed. When an update is needed, the central authority may need to identify and re-thread new end-to-end paths based on a new topology or a new operational status.

Determining that an update is needed can also be in response to a periodic refresh timer. In one embodiment, periodic refresh of match-action rules throughout the switched transport network is an ongoing process and can occur continuously rather than in response to a specific timer event. For example, in such an embodiment, refreshing match-action rules within the switched transport network occurs as quickly as the central authority is able to refresh constituent switch systems of the switched transport network.

When an update is needed, the method proceeds back to step 410, although if no change in network endpoints has occurred and no end-to-end paths need to be identified, the method may skip steps 410 and 412 and proceed directly to step 414.

FIG. 5A illustrates an exemplary switched transport network 530, in accordance with one embodiment. As shown, switched transport network 530 includes entry switches EnS1 and EnS2, coupled to intermediate switches S1 through S7, the intermediate switches further coupled to exit switches ExS1 and ExS2. The switches operate to establish a plurality of potential unidirectional end-to-end paths from each source (Src1-Src3) to each destination (Dst1-Dst3). Unidirectional end-to-end paths are similarly provided in the reverse direction through switched transport network 530. In other embodiments, more or fewer entry switches and/or exit switches can be included, and more or fewer intermediate switches and/or different topologies can also be included. The sources can be coupled to a given entry switch through private network 520(0) and destinations coupled to a given exit switch through private network 520(1). Server to server data communication is generally described herein as a unidirectional path for data; however, in normal operation server to server data communication is typically bidirectional, comprising at least two unidirectional paths.

A private network is generally defined herein as a network of switches co-located with server systems (e.g., source systems and/or destination systems) in a physically secure facility. A private network can also be implemented as a secure virtual network coupled to virtual machines within a secure virtual environment or within a secure physical facility. For example, in a controlled, physically secure machine room with a plurality of physical computer servers, a network of switches and links coupling the computer servers together within the machine room would represent a private network.

Furthering the above example, switched transport network 530 can include switch systems also disposed within the secure machine room, but with transport links exiting the physical security of the machine room, thereby creating potential physical attack vulnerabilities. In such a system configuration, the sources, along with private network 520(0), entry switches EnS1 and EnS2, and intermediate switches S1, S3, S5 can be physically disposed within one machine room facility in a first city, while intermediate switches S2, S4, S6, S7, exit switches ExS1 and ExS2, private network 520(1), and the destinations can be physically disposed within a second machine room facility in a second city, the two cities being separated by many miles or thousands of miles. Data that traverses network topology cross-section 531 is potentially vulnerable to a physical and/or subsequent cryptographic attack. Data that traverses network cross-section 531 can be advantageously protected from such attacks using techniques disclosed herein. This data can be transmitted using medium haul and/or long haul optical transmission techniques, including multi-wavelength techniques, and/or frequency-division multiplexing for increased reach and dispersion performance within physical media. In an alternative embodiment, private networks 520, switched transport network 530, and related servers (Src1-Src3, Dst1-Dst3) are disposed within the secure machine room, the switched transport network 530 providing a high-throughput network between the endpoints. In such an alternative embodiment, the secure machine room may include multiple tenants, with traffic from one tenant crossing through regions operating by other tenants, thereby creating potential circumstances for a data security threat.

In one embodiment a central authority (CA) 580 operates to configure the various switch systems within switched transport network 530 (e.g., as described herein). For example, central authority 580 is configured to perform at least method 400 in conjunction with configuration operations for switched transport network 530. Furthermore, entry switches (e.g., EnS1 and EnS2) are configured to operate according to the methods and descriptions disclosed in conjunction with FIGS. 1A-1F. Intermediate switches (e.g., S1-S7) are configured to operate according to the methods and descriptions disclosed in conjunction with FIGS. 2A-2F. Exit switches (e.g., S1-S7) are configured to operate according to the methods and descriptions disclosed in conjunction with FIGS. 3A-3F.

FIG. 5B illustrates a switched transport network 530 comprising a transport link 532, in accordance with one embodiment. As shown, server group 510(0) comprises server systems 512(0) through 512(N) and server group 510(1) comprises server systems 514(0) through 514(M). Servers 512 can act as source systems in a unidirectional communication to destination systems, comprising servers 514; furthermore, servers 514 may act as source systems in a unidirectional communication to destination systems, comprising servers 512. A first unidirectional end-to-end path from a first server 512 to a second server 514, in combination with a second unidirectional end-to-end path from the second server 514 to the first server 512 forms a bidirectional end-to-end communications channel. The first and the second unidirectional end-to-end paths of the bidirectional end-to-end communications channel can be threaded along different physical links and can involve different switch systems in at least a portion of the switched transport network 530.

In one embodiment, each of the unidirectional end-to-end paths between servers 512 and 514 is threaded through the switched transport network 530. The unidirectional end-to-end paths can be further threaded through private networks 520. In certain embodiments, the switched transport network 530 is configured by central authority 580, as described previously.

In one embodiment, switched transport network 530 comprises at least two transport systems 534(0) and 534(1) configured to communication through a transport link 532. In one embodiment, transport systems 534 are configured to transmit optically encoded data on multiple wavelengths through each of one or more optical fibers comprising the transport link 532. In one embodiment, transport systems 534 implement dense wavelength division multiplexing (DWDM). In certain embodiments, a given wavelength transponder within a transport system 534 is modulated to implement frequency division multiplexing (FDM) associated with the wavelength. Transport link 532 can operate to transmit data traffic associated with a topology cross-section, such as cross-section 531.

In one embodiment, transport systems 534 each include a plurality of ports (not shown), such as Ethernet ports. The Ethernet ports can be optical, electrical, or any combination thereof. Transport systems 534 transmit ingress traffic at a given port to a corresponding wavelength or FDM channel associated with a wavelength for transmission along transport link 532. Similarly, transport systems 534 provide data transmission in the opposite direction, with data received at a specific wavelength sent to a corresponding port (e.g. coupled to a specific port of a switch 536). Furthermore, transport systems 534 may map traffic from one port onto multiple FDM channels modulated onto one or more wavelengths for transmission. Switches 536 are configured to receive and forward traffic from an associated private network 520 to specific ports of an associated transport system 534. In one embodiment, different data transmission wavelengths comprise network links between switch ports and threading an end-to-end path includes selecting a wavelength as a link between switch ports. In this way, a specific tag within an ingress data frame received at a switch 536 from private network 520(0) determines which port is used to transmit the data frame to transport system 534, and therefore which wavelength is used to transmit the data frame along transport link 532.

FIG. 5C illustrates transport systems 534 and a dense wavelength division multiplexing (DWDM) transport link 532, in accordance with one embodiment. As shown, transport system 534(0) includes input ports 540(1) through 540(N). Traffic arriving at input port 540(1) is transmitted on wavelength λ1 within transport link 532. Traffic arriving at input port 540(2) is transmitted on wavelength λ2, and so forth. Traffic arriving on wavelength λ1 within transport link 532 at transport system 534(1) is transmitted to output port 542(1). Traffic arriving on wavelength λ2 within transport link 532 at transport system 534(1) is transmitted to output port 542(2), and so forth. In one embodiment, wavelengths λ1-λN are transmitted within a single fiber optic channel within transport link 532. In one embodiment, input ports 540 and output ports 542 implement a frame-based data transmission physical layer, such as optical and/or electrical Ethernet standards known in the art. Transport systems 534 can implement any technically feasible techniques for mapping a data frame (e.g. Ethernet frame) for transmission to an optical data signal at a selected wavelength, such techniques including multiplexing the multiple wavelengths into a single fiber optical channel, (e.g., a single mode optical fiber). In certain embodiments, standard wavelengths are selected for data transmission. In alternative embodiments, wavelength shift and/or modulation may be implemented.

In one embodiment, central authority 580 configures transport systems 534, to at least assign input ports 540 to wavelengths and assign wavelengths to output ports 542. Threading an end-to-end path between two endpoints can include mapping an input port 540 to a wavelength and the wavelength to an output port 542. Threading the end-to-end path may alternatively include an existing port to wavelength mapping. In either case, central authority 580 can configure various such mappings within and among transport systems 534.

FIG. 5D illustrates a conceptual forwarding subsystem 500, in accordance with one embodiment. As shown, forwarding subsystem 500 includes an ingress pipeline 550 coupled to an egress pipeline 560 through a data buffer/fabric 558. Ingress data frames from an input port are transmitted to an ingress interface 552, which is configured to parse an input data frame. Such parsing may include, without limitation, extracting bit field data based on programming instructions or configuration parameters. One or more match stages 554 are configured to perform match-action rules on extracted bit field data. The match-action rules may be nested or non-nested. A data formatting stage 556 writes processed data comprising at least bit field data subjected to match-action rules into buffer/fabric 558. In one embodiment, buffer/fabric 558 comprises a memory buffer which may be read by one or more instances of ingress pipeline 550 and one or more instances of egress pipeline 560. In systems with two or more egress pipelines 560 (two or more instances of egress pipeline 560), data written to buffer/fabric 558 may be retrieved and transmitted through a selected egress pipeline 560 based on a forwarding rule implemented within ingress pipeline 550. In other embodiments, buffer/fabric 558 comprises a fabric switch configured to transmit processed data from one of a plurality of ingress pipelines 550 to one egress pipeline 560 for transmission. Buffer/fabric 558 may include a cross-bar, multi-hop mesh, or any other technically feasible data routing structure(s), implemented as physical circuits or virtual circuits, for routing data from one of potentially many ingress pipelines 550 to one of potentially many egress pipelines 560. Egress pipeline 560 may provide zero, one, or more match stages 562 for further processing of frame data, such processing also conducted in accordance with programming instructions and/or configuration parameters. An egress formatting unit 566 formats processed frame data into an egress data frame for transmission through an output port.

Conceptual forwarding subsystem 500 illustrates one of various approaches for implementing a forwarding subsystem. In general, any programmable and/or configurable forwarding subsystem that is able to perform methods 102, 202, and 302 may be implemented without departing the scope and spirit of various embodiments.

FIG. 5E illustrates a link security system 570, in accordance with one embodiment. As shown, link security system 570 includes a control plane agent 572, a forwarding subsystem 576 (e.g., forwarding subsystem 500), an ingress physical layer interface (PLI) 574, and an egress PLI 578. Ingress PLI 574 is configured to receive physical signals associated with a physical ingress port 573. In one embodiment, PLI 574 comprises an optical Ethernet adapter configured to receive optical Ethernet signals associated with ingress port 573 and convert the optical signals into electrical signals for processing by the forwarding subsystem 576. Furthermore, PLI 578 can comprise an optical Ethernet adapter configured to convert electrical signals, generated by forwarding subsystem 576 to represent egress data frames, into physical optical Ethernet signals for transmission through egress port 579. In alternative embodiments, one or more instances of ingress PLI 574 and egress PLI 578 implement standard electrical (wired) Ethernet signaling.

Control plane agent 572 is configured to communicate with a central authority 580 through a control plane network 582. Communication between control plane agent 572 and central authority 580 may be encrypted and/or otherwise protected using any technically feasible techniques. Furthermore, control plane network 582 may be physically and/or logically isolated from other traffic. In various embodiments, central authority 580 transmits control messages to control plane agent 572 to convey match-action rules to control plane agent 572. In one embodiment, control plane agent 572 performs one or more of methods 100, 200, and/or 300 described herein. Control plane agent 572 is configured to program forwarding subsystem 576 to perform match-action rules specified by central authority 580 on ingress data frames received at ingress port 573 to generate egress data frames transmitted from egress port 579. Exemplary processing of ingress data frames to generate egress data frames is described herein.

In one embodiment, link security system 570 comprises one ingress port 573 and one egress port 579. Such a system can be configured to provide link security to a unidirectional path, such as a unidirectional path within switched transport network 530. Furthermore, a plurality of independent link security systems 570 can provide independent link security on corresponding unidirectional paths. The plurality of link security systems 570 can be packaged separately, or within a common chassis. The plurality of link security systems 570 can be controlled by a common control plane agent 572 or corresponding independent control plane agents 572.

In another embodiment, link security system 570 comprises two or more ingress ports 573 and two or more egress ports 579, with a shared forwarding subsystem 576 that is configured to process and route ingress data frames arriving at one ingress port 573 to one or more (e.g., multicast) selected egress ports 579. Such an embodiment may be implemented as a physical switch, such as an Ethernet switch, with a programmable/configurable forwarding subsystem 576 that is suitably designed to implementing methods 102, 202, and 302 described herein. Such an embodiment may also be implemented as a virtual switch, such as an OpenFlow vSwitch (virtual switch).

In certain embodiments, bit field encryption is performed using a fixed-rate encryption/decryption technique, such as the encryption standard known in the art as advanced encryption standard (AES). In other embodiments, variable-rate encryption/decryption techniques may be performed. In either case, an ingress data frame may have a different length versus a corresponding egress data frame.

In one embodiment, whole data frames are transmitted encrypted and decrypted to determine forwarding information. In such embodiments, ingress data frames are decrypted, according to decryption key information provided by central authority 580, to extract forwarding information such as a destination address or ingress tag. Data comprising a whole egress data frame may be encrypted prior to transmission. In such an embodiment, match-action rules are performed on decrypted ingress data frame data.

In one embodiment, the central authority 580 is implemented in conjunction with an OpenFlow Controller (OFC) and/or OpenFlow FlowVisor (OFV). Alternatively, an OFC and/or OFV may operate orthogonally to central authority 580. For example, the OFC and/or OFV may be configured to perform standard OpenFlow configuration tasks, while the central authority 580 is configures network systems to provide link security.

Methods 100, 102, 200, 202, 300, 302, 400 may be implemented as a software program products comprising programming instructions stored within non-transitory computer-readable media. The programming instructions, when executed by a respective processing unit, cause the processing unit to perform a respective method. Exemplary non-transitory computer-readable media includes magnetic hard disk drives, semiconductor storage drives (e.g., SSD), optical storage media, solid-state system memory, and the like.

While entry switches, such as EnS1 and EnS2 of FIG. 5A, are described herein as physical systems, an entry switch may also be implemented as a virtual switch without departing the scope of the present disclosure. For example, an entry switch may be implemented as an OpenFlow Open vSwitch. Similarly, an exit switch, such as ExS1 and ExS2, may be implemented as a virtual switch. In one embodiment, at least one entry switch is implemented as a virtual switch within a first multi-processing server system, and at least one exit switch is implemented as a virtual switch within a second multi-processing server system. In certain embodiments, the first multi-processing server system may be coupled to the second multi-processing server system through a switched transport network 532 comprising at least two transport systems, such as transport system 534(0) and 534(1). Furthermore, the switched transport network 532 may comprise one or more intermediate switches. The entry switches may implement methods 100 and 102, while the exit switches may implement methods 300 and 302. Intermediate switches may implement methods 200 and 202. In such embodiments, network link security starts within each multi-processor server, and a private network 520 can include one or more ranks of intermediate switches coupled to either intermediate switches at the edge of switch transport network 520, or ports of one or more transport systems 534. In one embodiment, central authority 580 operates within each private network and can be connected to a central authority proxy, which controls vSwitches operating in remote severs in different private network(s). Alternatively, central authority 580 connects directly to remote servers through a control plane network 582. In a fault scenario where control plane network 582 fails, the central authority 580 can be configured to pause various refresh operations until communication between the central authority 580 and the remote servers is re-established.

In one embodiment each different transport link 532 (e.g., fiber optic channel) is managed by a different central authority 580. For example, a first instance of central authority 580 can provide port to wavelength mappings for transport systems 534 on either end of the transport link 532. In other embodiments, multiple transport links are managed by a single central authority 580.

Embodiments of the present disclosure provide link-level security by advantageously obfuscating any association between data encoded within different data frames transmitted along a given link. Even complete observation of ingress and egress traffic at a particular switch does not provide enough information for an attacker to identify endpoints between which any given data frame traverses. Consequently, even an extremely robust decryption attack may be significantly confounded by a combinatorial explosion of possible data frame associations and non-associations. For example, a sequence of one hundred conventional fifteen-hundred byte data frames (less than two hundred microseconds of traffic on a 10G Ethernet data link) would introduce an additional combinatorial association problem of one hundred factorial (˜9.3 E+157) possible data frame associations on top of any orthogonal encryption associated with one or more of the one hundred data frames. A decryption attack on such a data link would need to solve both the combinatorial association problem and the orthogonal encryption. Persons skilled in the art will recognize that the techniques disclosed herein introduce computational barriers to a decryption attack on the order of or greater than current encryption techniques alone. A combination of conventional payload encryption and the present techniques for obfuscating data frame association create even larger computational barriers to a successful attack. The present techniques contrast with conventional data frame transmission techniques that preserve source and destination information in plaintext headers, thereby limiting the computational attack barrier to that of a payload encryption technique.

Embodiments of the present disclosure comprising a DWDM transport link 532, may provide end-to-end paths that persist on one or more wavelengths until refreshed by central authority 580, after which any potentially successful attack will be stale. A given end-to-end path may involve multiple wavelengths when link bundling is implemented at endpoints and each different link in a bundle is threaded along a different wavelength. Central authority 580 may refresh end-to-end paths with any technically feasible timing (e.g., every second, a random amount of time, etc., as an implementation choice for central authority 580), and without interrupting end-to-end traffic between associated endpoints. Furthermore, in a DWDM implementation, the association problem generally grows with the number of wavelengths factorial, creating a yet larger computational barrier to an attack.

In certain embodiments, decoy data frames can be transmitted through a switched transport network (e.g., when user traffic utilization is sufficiently low otherwise) to further hinder an attacker. In one embodiment, entry switches advertise a maximum transmission unit (MTU) of a standard size (e.g. 1500 bytes) and/or pad up smaller data frames to one or more quantized sizes (e.g., when utilization is sufficiently low), including the standard size, to obfuscate association by size.

1. A method, comprising:
learning, by a central authority system, endpoints within a switched network, wherein the switched network comprises at least a first entry switch and a first exit switch, and wherein the endpoints comprise network interfaces to the switched network;
identifying, by the central authority system, end-to-end paths within the switched network, wherein the end-to-end paths traverse a first entry switch and a first exit switch, and each end-to-end path includes a first source endpoint and a first destination endpoint;
computing, by the central authority system, a set of match-action rules for an end-to-end path, wherein the match-action rules define a first forwarding path that includes the first entry switch and the first exit switch; and
transmitting, by the central authority system, a first match-action rule from the set of match-action rules to the first entry switch and a second match-action rule from the set of match-action rules to the first exit switch,
wherein the first entry switch is configured to receive data frames from the first source endpoint and the first exit switch is configured to transmit data frames to the first destination endpoint.

2. The method of claim 1, further comprising transmitting, by the central authority system, a first control message to remove a match-action rule from the first entry switch and transmitting a second control message to remove a match-action rule from the first exit switch.

3. The method of claim 1, wherein the first forwarding path comprises a unidirectional path from the first source endpoint to the first destination endpoint.

4. The method of claim 1, wherein the first match-action rule specifies a match value equal to an address pair comprising a source address of the first source endpoint and a destination address of the first destination endpoint and corresponding first action rules.

5. The method of claim 4, wherein the first action rules comprise overwriting an ingress address pair comprising the address pair with a specified tag value to generate an egress data frame.

6. The method of claim 5, wherein the first action rules comprise selecting an egress port of the entry switch and queuing the egress data frame for transmission through the egress port.

7. The method of claim 5, wherein the first action rules comprise encrypting an ingress payload to generate an egress payload using an encryption key included in the first action rules.

8. The method of claim 1, wherein the second match-action rule specifies a match value equal to a tag value and a corresponding second action rules.

9. The method of claim 8, wherein the second action rules comprise overwriting an ingress tag comprising the tag value with a specified address pair to generate an egress data frame.

10. The method of claim 9, wherein the second action rules comprise selecting an egress port of the exit switch and queuing the egress data frame for transmission through the egress port

11. The method of claim 9, wherein the second action rules comprise encrypting an ingress payload to generate an egress payload using at least one encryption key included in the second action rules.

12. The method of claim 1, wherein the switched network further comprises a first intermediate switch and the identified end-to-end paths traverse the first intermediate switch.

13. The method of claim 12, further comprising transmitting, by the central authority system, a third match-action rule from the set of match-action rules for the first intermediate switch.

14. The method of claim 13, wherein the third match-action rule specifies a match value equal to a tag value and corresponding third action rules.

15. The method of claim 14, wherein the third action rules comprise overwriting an ingress tag comprising the tag value with a specified tag value to generate an egress data frame.

16. The method of claim 15, wherein the third action rules comprise selecting an egress port of the intermediate switch and queuing the egress data frame for transmission through the egress port.

17. The method of claim 15, wherein the third action rules comprise encrypting an ingress payload to generate an egress payload using an encryption key included in the third action rules.

18. The method of claim 15, wherein the third action rules comprise decrypting an ingress payload to generate a plaintext payload using a first encryption key, and encrypting the plaintext payload using a second encryption key to generate an egress payload.

19. The method of claim 1, wherein the first entry switch is coupled to a first dense wavelength division multiplexing (DWDM) transport system and the first exit switch is coupled to a second DWDM transport system configured to communicate with the first DWDM transport system through a plurality of wavelength channels, and wherein identifying the end-to-end paths within the switched network includes identifying corresponding wavelength channels to be traversed by the end-to-end paths.

20. A non-transitory computer readable storage medium, including programming instructions therein that, when executed by a processing unit, cause the processing unit to:
learn endpoints within a switched network, wherein the switched network comprises at least a first entry switch and a first exit switch, and wherein the endpoints comprise network interfaces to the switched network;
identify end-to-end paths within the switched network, wherein the end-to-end paths traverse a first entry switch and a first exit switch, and each end-to-end path includes a first source endpoint and a first destination endpoint;
compute a set of match-action rules for an end-to-end path, wherein the match-action rules define a first forwarding path that includes the first entry switch and the first exit switch; and
transmit a first match-action rule from the set of match-action rules to the first entry switch and a second match-action rule from the set of match-action rules to the first exit switch,
wherein the first entry switch is configured to receive data frames from the first source endpoint and the first exit switch is configured to transmit data frames to the first destination endpoint.
